(19) United States
(12) Patent Application Publication
(10) Pub. No.: US 2006/0113397 A1
(43) Pub. Date: Jun. 1, 2006

(54) Pallet tag/label carrier

(75) Inventors: Kai Beilenhoff, Wahlen (DE); Ulrich Schafer, Wetzlar (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Checkpoint Systems, Inc., Thorofare, NJ (US)

(21) Appl. No.: 11/214,119

(22) Filed: Aug. 29, 2005

Related U.S. Application Data
(60) Provisional application No. 60/629,111, filed on Nov. 18, 2004.

(51) Int. Cl. G06K 19/06; G08B 13/14; G06F 7/00

(52) U.S. Cl. 235/494; 340/572.8; 700/215

(57) ABSTRACT

A pallet tag and label carrier that can be easily and releasably secured to a pallet and which includes product identification indicia, such as a UPC or EAN code, and also includes an electrically-activatable identification tag such as an EAS or RFID tag. The pallet tag and label carrier is formed of a material that allows portions thereof to yield to external forces without breaking.

### BACKGROUND OF THE INVENTION

1. Field of Invention

This invention relates to generally to product identification, and more particularly, to a durable and easy-to-use pallet tag and label carrier that can be releasably secured to pallets.

2. Description of Related Art

In an effort to track products more efficiently and accurately, the use of RF (radio frequency) technology, including RFID (RF identification), is being incorporated into product carriers or packaging or even into the products themselves. Although these tags may use various wireless interrogation technologies, such as acousto-magnetic (AM), electromagnetic (EM), etc., the preferred technology is the use of RFID.

RFID tags typically comprise a resonant circuit, or antenna, along with an integrated circuit (IC). The IC contains a memory which stores any variety of product-related data and usually includes the product's serial number or other unique identification data. Usually, these RFID tags are passive, i.e., they contain no power source thereon. The resonant circuit or antenna is tuned to a particular RF frequency or band. When the RFID tag comes within range of an RFID reader which emits a signal to which the resonant circuit (or antenna) is tuned, the IC is momentarily powered by the incoming signal and a response signal is emitted by the RFID tag back to the RFID reader. The RFID reader processes the response signal and is now able to identify the products associated with that particular RFID tag.

In addition, a more well-known product identifier, the UPC (universal product code) is typically associated with products to provide product identification. The UPC is a bar code that is optically detected and decoded. The UPC was adopted in 1973 and was initially used by the grocery industry for product marking. In 1976, another similar product identifier, the EAN (European article number) was adopted in Europe. Like the UPC, the EAN is an optically detected and decoded bar code.

In many instances, it is necessary to identify large quantities of products that are secured on a single pallet during storage or shipping. Information about the products (e.g., product serial number range, lot number, etc.) secured on a particular pallet can be obtained quickly from an RFID tag and/or a UPC (or EAN) label that is associated with that pallet. However, in order for the RFID tag and/or the UPC/EAN label to operate properly, these tags/labels must be secured and protected from damage during shipping and storage of the overall pallet. For example, the RFID tag and/or the UPC/EAN label must be protected from damage due to impact by movement in the warehouse environment (e.g., forklift, product shifting on the pallet itself, etc.). Thus, there remains a need for a tag/label securement device for securing and protecting an RFID tag and/or a UPC/EAN label on a pallet and which can be easily secured to, or released from, the pallet and which can be attached to any edge of the pallet.

All references cited herein are incorporated herein by reference in their entireties.

### BRIEF SUMMARY OF THE INVENTION

A label carrier for use with a pallet having products stored thereon and having pallet edges and upper and lower pallet surfaces. The label carrier comprises: a first member and a second member that are oriented substantially perpendicular to each other; releasable securing means (e.g., a clip comprising spring steel) that releasably secures the first and second members to an edge of the pallet, wherein the releasable securing means positions the second member to be in contact with the upper pallet surface and positions the first member to be contact with the pallet edge; and wherein the first member includes a label comprising optically-encoded data (e.g., an EAN or UPC code) thereon.

An identification tag carrier for use with a pallet having products stored thereon and having pallet edges and upper and lower pallet surfaces. The identification tag carrier comprises: a first member and a second member that are oriented substantially perpendicular to each other; releasable securing means (e.g., a clip comprising spring steel) that releasably secures the first and second member to an edge of the pallet, wherein the releasable securing means positions the second member to be in contact with the upper pallet surface and positions the first member to be contact with the pallet edge; and wherein the first member includes an identification tag (e.g., an RFID tag, an EAS tag, etc.) which supports wireless communication.

### BRIEF DESCRIPTION OF SEVERAL VIEWS OF THE DRAWINGS

The invention will be described in conjunction with the following drawings in which like reference numerals designate like elements and wherein:

FIG. 1A is an exploded isometric view showing the tag carrier and clip portions of the present invention from its label side;

FIG. 1B is a reduced isometric view showing the clip portion engaged with the tag carrier of the present invention;

FIG. 2A is an exploded isometric view showing the tag carrier and the identification tag of the present invention from its identification tag side;

FIG. 2B is a reduced isometric view showing the identification tag secured within the tag carrier of the present invention from its identification tag side;

FIG. 2C is an isometric view of the present invention installed on a pallet having product thereon, shown in part;

FIG. 3A is an exploded isometric view showing the EAN (or UPC) label and the tag carrier of the present invention from an outside position;

FIG. 3B is a reduced isometric view showing the EAN (or UPC) label secured to the outside surface of the tag carrier from its identification tag side;

FIG. 4A is a partial view of the present invention installed on the edge of a pallet, shown partially;

FIG. 4B is a reduced view of the present invention installed on the pallet as shown in FIG. 4A;

FIG. 5A is an isometric view showing the tab/label carrier being positioned in preparation to engage the pallet;

FIG. 5B is an exploded isometric view of the tag/label carrier and the clip depicting how the clip is used to releasably secure the tag/label carrier to the edge of the pallet, shown partially;

FIG. 6A is a plan view of the present invention installed on the pallet having product thereon in accordance with FIG. 2C;

FIG. 6B is an isometric view of the present invention installed on the pallet without any product being placed on pallet;

FIG. 7A is a side view of the pallet showing the present invention installed thereon and with a forklift tine impacting the tag/label carrier portion and depicting how the tag/label carrier portion yields to the force without breaking;

FIG. 7B is also a side view of the pallet showing the present invention installed thereon and with product on the pallet impacting the tag/label carrier portion and depicting how the tag/label carrier portion yields to the force without breaking; and

FIG. 8 is an alternate embodiment wherein the tag/label carrier is formed of two distinct members.

### DETAILED DESCRIPTION OF THE INVENTION

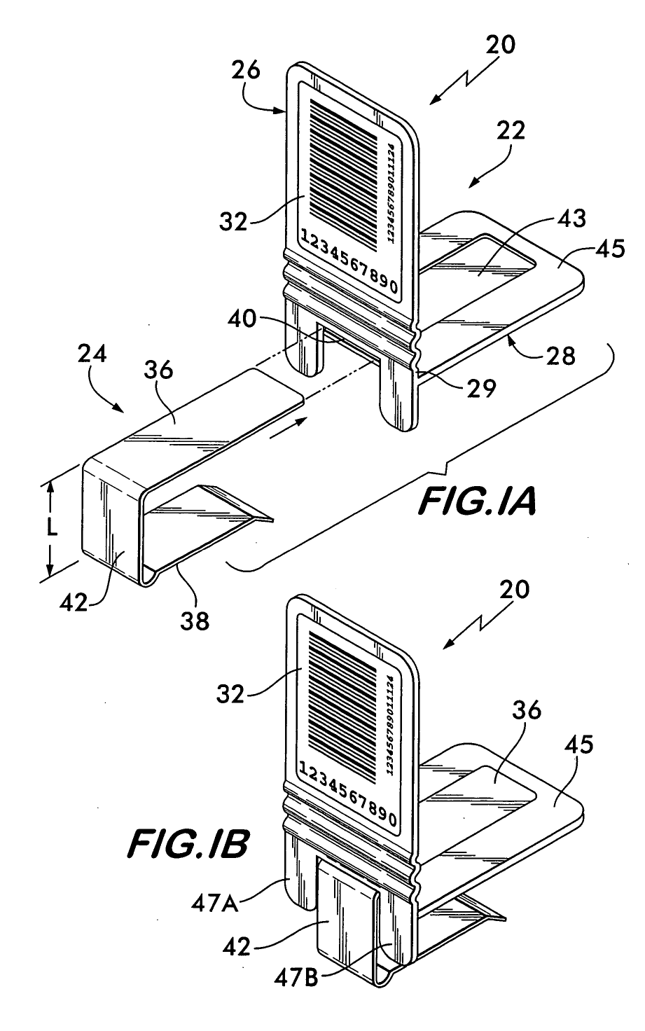

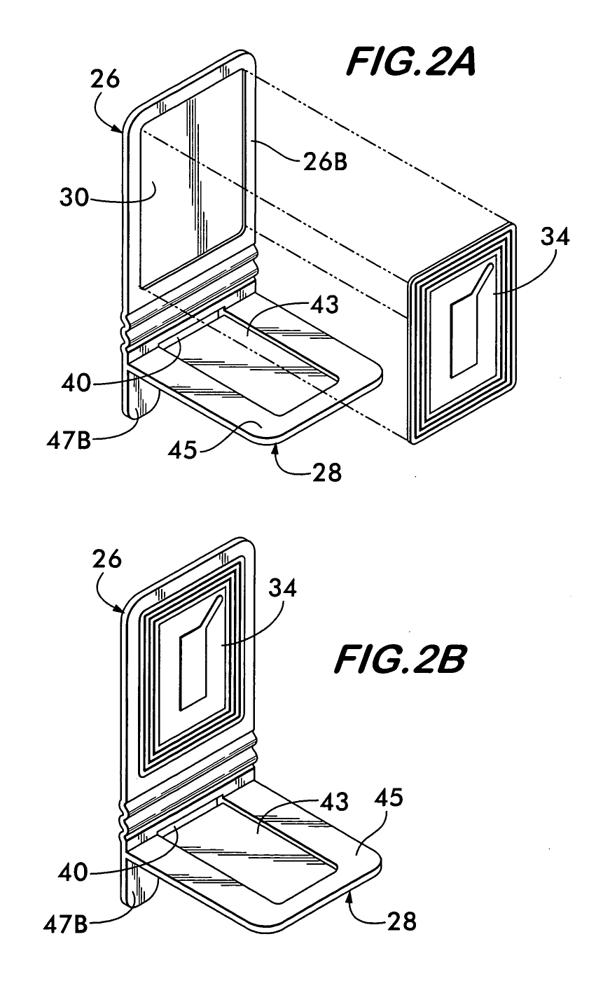

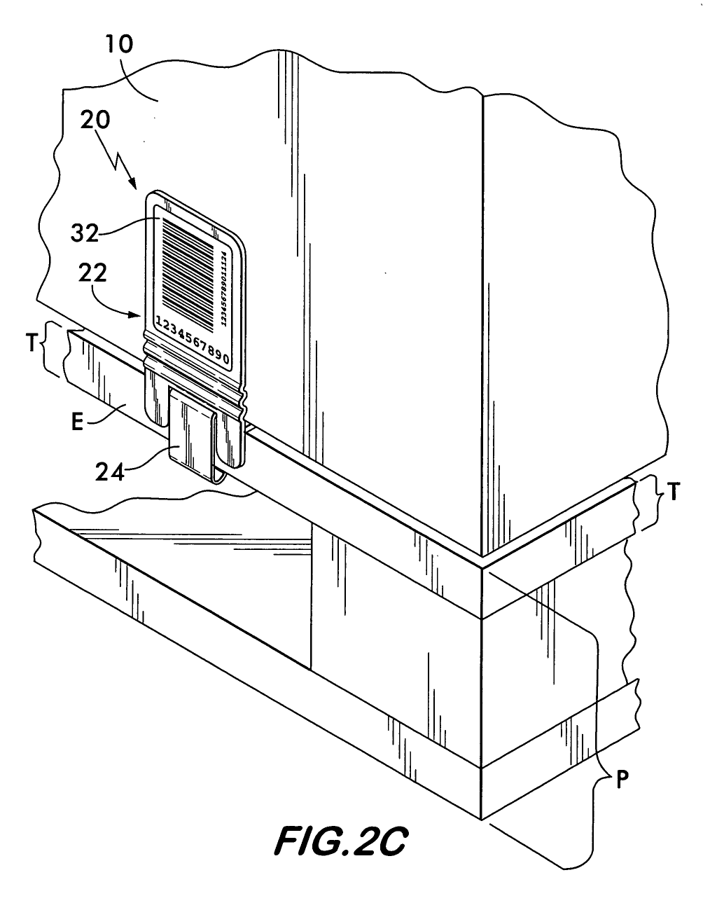

As shown in FIGS. 1A-2C, the present invention 20 comprises a tag/label carrier 22 and a clip 24 that forms a releasable securing mechanism to releasably secure the carrier 22 to a pallet P (FIG. 2C) for containing product(s) 10 thereon. The tag/label carrier 22 (FIG. 1A) comprises a first member 26 and a second member 28 that are formed into an “L-shaped” configuration. The first member 26 comprises an outside surface 26A having a depression 28 (FIG. 3A) therein and an inside surface 26B having a depression 30 (FIG. 2A) therein. The depression 28 receives an EAN (or UPC) label 32 therein whereas the depression 30 receives an identification tag 34, e.g., an RFID tag. The depressions 28/30 recess their respective label 32 and tag 34 within their respective outside/inside surfaces 26A/26B, thereby eliminating any exposed edge of the label 32 or tag 34 that can be snagged by another moving object that comes in contact with the outside or inside surfaces 26A/26B. The EAN label 32 and identification tag 34 may be secured within their respective depressions 28/30 using an adhesive. As a result, the EAN label 32 is outwardly-faced, thereby allowing the EAN code to be scanned whereas the identification tag 34 is inwardly-facing (towards the product(s) 10 on the pallet P) since no optical path to the tag 34 is required for wireless communication.

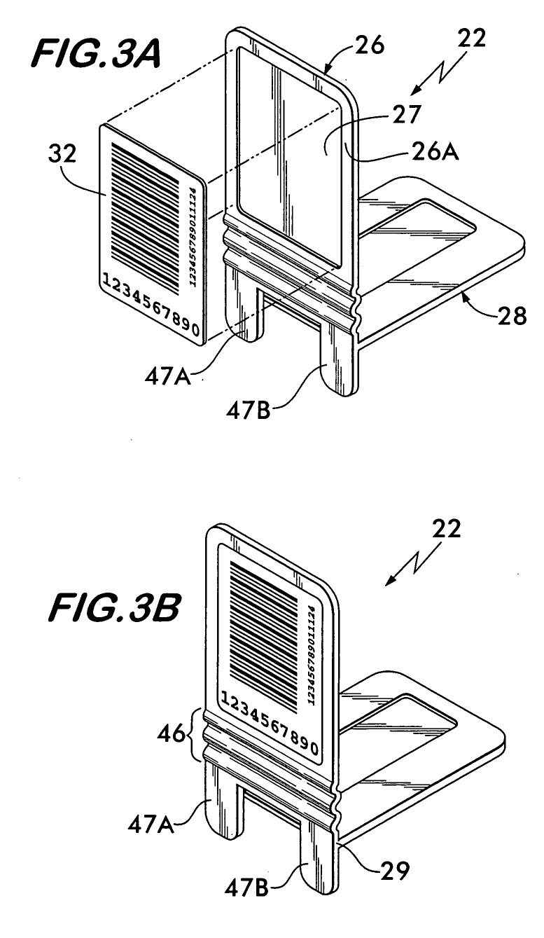

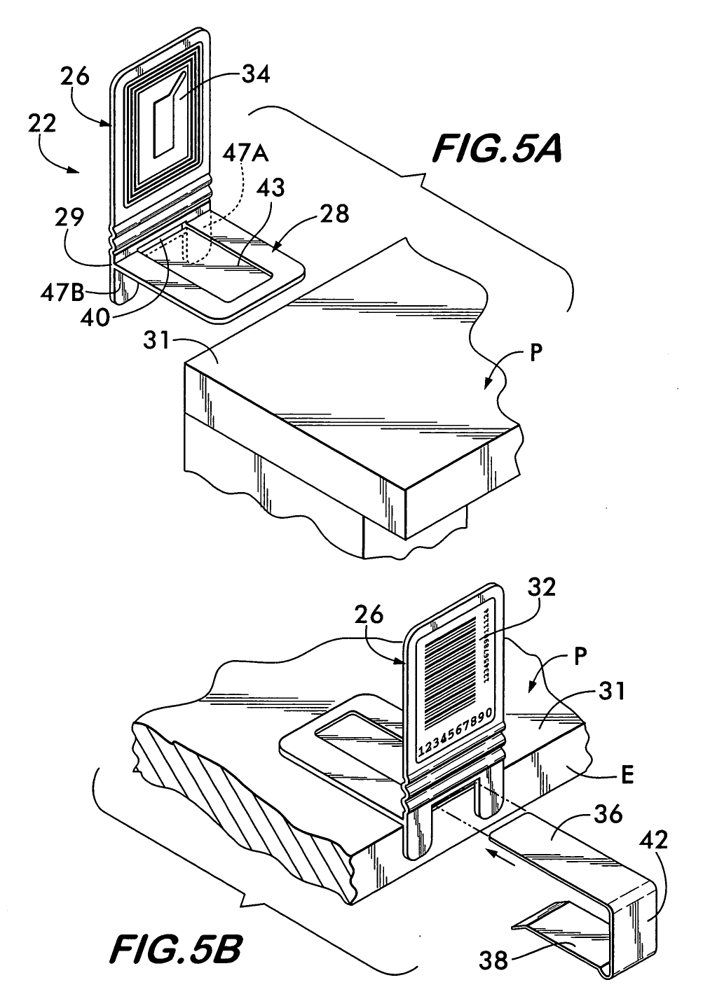

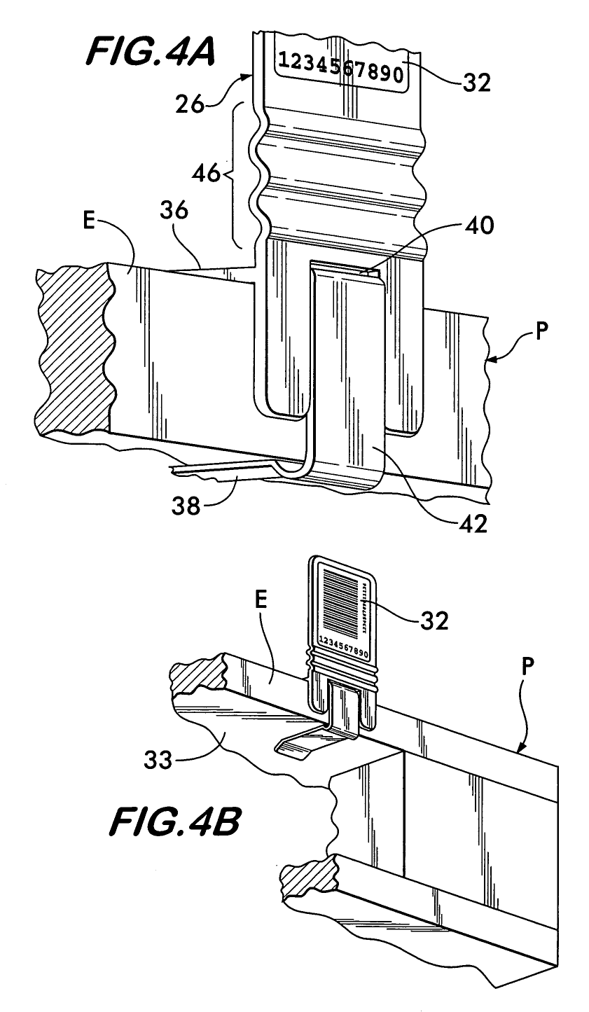

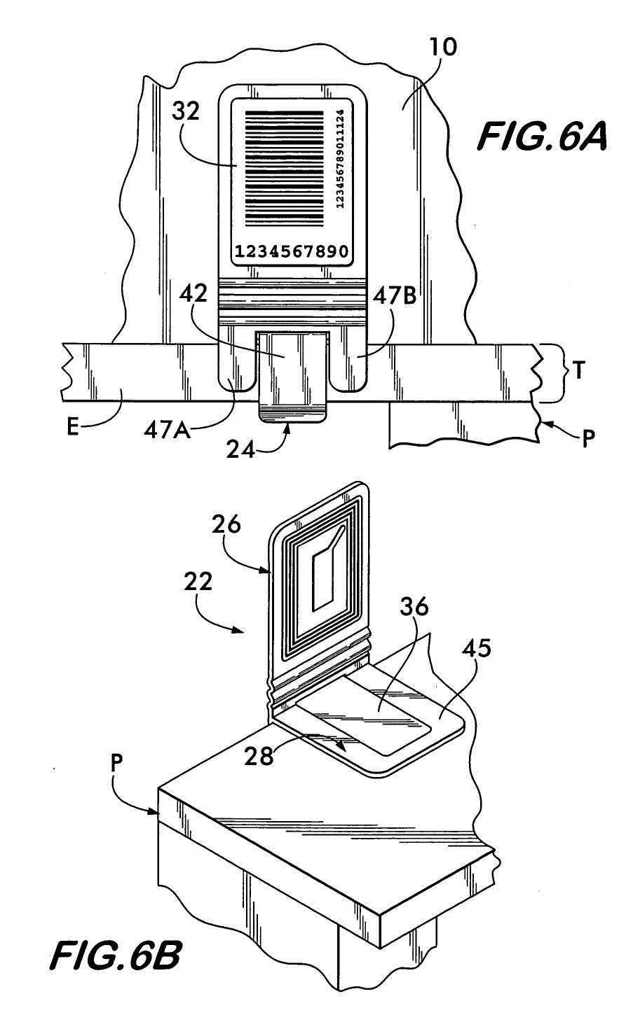

The clip 24 (FIG. 1A) comprises a “U-shaped” configuration wherein a first tong 36 passes through the tag carrier 22 and forces the second member 28 against the upper surface 31 of the pallet (FIG. 6B) while a second tong 38 presses against an underside surface 33 of the pallet, as shown most clearly in FIG. 4B. The clip 24 may comprise a spring steel. In particular, the first tong 36 slides through an aperture 40 formed above the common edge 29 (FIG. 1A) of the first member 26 and the second member 28 and is received in a depression 43 in the top surface 45 of the second member 28. As can be seen most clearly in FIGS. 2A/2B, the depression 43 permits the first tong 36 to be flush with the top surface 45 (see FIG. 1B) of the second member 28 when it is installed, thereby releasably securing the tag/label carrier 22 to the pallet P; this eliminates any raised surface of the clip 24 that could interfere with product(s) 10 that are secured to the pallet P and on top of the second member 28 which is positioned on top of the pallet P's surface 31 (FIGS. 5A-5B). A middle portion 42 of the clip 24 joins the first tong 36 and the second tong 38. Spreading the tongs 36/38 away from each other against the bias of the material (e.g., spring steel) allows the front ends of the tongs 36/38 to be pushed over the edge E of the pallet P (see FIGS. 5A-5B) to secure the tag/label carrier 22 to the pallet P; or conversely, to release the tag/label carrier 22 from the edge E. The first member 26 comprises a pair of downwardly-projecting tongs 47A/47B that contact the outer edge of the pallet P surface when the clip 24 is slid through the aperture 40 and the inside surface of the middle portion 42 is pushed into contact with the pallet P edge E (see FIGS. 6A-6B). These tongs 47A/47B help brace the first member 26 against the edge E of the pallet P. In addition, it should be noted that the tongs 47A/47B act to prevent any exposed edge of the middle portion 42 from projecting outwardly that could be snagged by objects that come into contact with the edge E of the pallet during shipping or storage. Thus, the middle portion 42 also forms a flush surface with the tongs 47A/47B as shown most clearly in FIGS. 4A-4B and FIGS. 7A-7B.

It should be understood that clips 24 having different lengths L (FIG. 1A) for the middle portions 42 are available so as to allow the clip 24 to releasably secure the tag/label carrier 22 to a variety of pallets P having different edge thicknesses T (see FIG. 2C and FIG. 6A). Furthermore, it should be also understood that the tag/label carrier 22 can be secured to any portion on the edge of the pallet P and is not limited to a particular pallet location for securement. Because of the perpendicular orientation of the first and second members 26/28 of the tag/label carrier 22, this enables the present invention 20 to form a flush, right-angled placement against any edge E of the pallet P.

The tag carrier 22 comprises a soft and durable but structurally sturdy plastic (e.g., elastomer) that gives with forces applied to it, as shown in FIGS. 7A and 7B. In the preferred embodiment the first and second members 26/28 are formed of a single piece of sturdy plastic and form the edge 29 (FIG. 3B and FIG. 5A) to create the substantially perpendicular orientation of these two members 26/28. FIG. 7A shows a forklift tine F contacting the first member 26 from the outside surface 26A and causing it to rotate inward toward the second member 28. Because of its durable composition, the first member 26 yields to the force without cracking or breaking and is restored to its normally perpendicular position (with respect to the second member 28) when the force is withdrawn. Conversely, if a product 10 (FIG. 7B) on the pallet P is inadvertently pressed against the first member 26 (e.g., from improper stacking on the pallet P) from the inside surface 26B causing it to rotate away from the second member 28, again, the first member 26 yields to the force without cracking or breaking and is restored to its normally perpendicular position when the force is withdrawn. As can also be seen, the first member 26 comprises a convoluted portion 42 that is designed for high flexibility and facilitates bending, without cracking, the first member 26 away from or towards the second member 28.

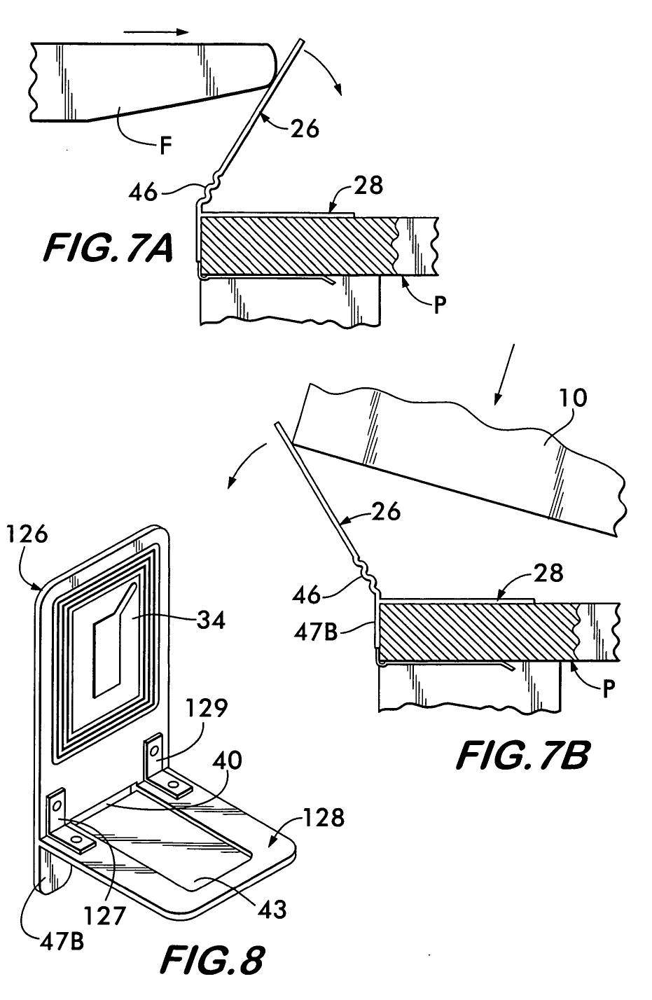

It should be understood that although the first member 26 and second member 28 are preferably formed into a unitary or integral configuration where they are oriented substantially perpendicular to each other, it is within the broadest scope of the present invention to include two distinct members that are coupled together to form the substantially perpendicular orientation. For example, as shown in FIG. 8, the first and second members 26/28 can be replaced by first and second members 126 and 128 that are individual members which are secured together using right-angles 127 and 129. These right-angles 127/128 may also comprise a steel spring or other equivalent material that provides a bias so that the first member 126 can rotate towards or away from the second member 128 during impact from either direction as shown in FIGS. 7A-7B.

It should also be understood that the present invention is not limited to the presence of both the EAN (or UPC) label 32 and the identification tag 34. The presence of either one of these is within the broadest scope of the present invention 20. Thus, for example, the identification tag 34 could be placed on either the outside surface 26A or the inside surface 26B with the EAN (or UPC) label 32 omitted. Similarly, the EAN (or UPC) label 32 could be present on the outside surface 26A (as mentioned previously, the EAN (or UPC) label 32 requires placement on the outside surface 26A where it can be optically read when there are products 10 stored on the pallet P). Therefore, the first member 26 may only comprise the EAN (or UPC) label 32 with no identification tag 34 present on the inside surface 26B.

It should be further understood that the identification tag 34 as used with the present invention 20 is not limited, in any way, to a particular wireless technology. Thus, the identification tag 34 may include both EAS (electronic article surveillance) technology or RFID technology, whose frequency range are typically defined as follows:

| EAS Operation | | RFID Operation | |
|---|---|---|---|
| Low Frequency (LF) | 5 kHz-14 kHz | High Frequency (HF) | 2 MHz-14 MHz |
| Acousto-Magnetic (AM) | 50 kHz-70 kHz | Ultrahigh Frequency (UHF) | 850 MHz-950 MHz |
| Radio Frequency (RF) | 2 MHz-14 MHz | Microwave Frequency | 2.3 GHz-2.6 GHz |

It should be understood that the term “identification tag” as used throughout this Specification includes any device which reflects electromagnetic energy for the purpose of identifying itself to a reader/interrogator and is not limited to only IC-based devices. Thus, an electronic article surveillance (EAS) tag, such as RF, EM or AM, would be considered a one-bit RFID tag. It should be further noted that it is within the broadest scope of the present invention to include identification tags 34 that are either passive (have no power source onboard the tag) or active (having an onboard power source).

While the invention has been described in detail and with reference to specific examples thereof, it will be apparent to one skilled in the art that various changes and modifications can be made therein without departing from the spirit and scope thereof.

What is claimed is:

1. A label carrier for use with a pallet having products stored thereon and having pallet edges and upper and lower pallet surfaces, said label carrier comprising:
a first member and a second member that are oriented substantially perpendicular to each other;
releasable securing means that releasably secures said first and second members to an edge of the pallet, said releasable securing means positioning said second member to be in contact with the upper pallet surface and positioning said first member to be contact with the pallet edge; and
wherein said first member includes a label comprising optically-encoded data thereon.

2. The label carrier of claim 1 wherein said releasable securing means comprises a clip having a U-shaped configuration comprising a pair of tongs.

3. The label carrier of claim 2 wherein said first member and said second member form a carrier edge and wherein said first member comprises an aperture for permitting passage of one of said tongs.

4. The label carrier of claim 3 wherein said second member comprises a depression therein, said depression receiving said one of said pair of tongs which passes through said aperture and presses downward against said upper pallet surface.

5. The label carrier of claim 4 wherein said clip comprises spring steel.

6. The label carrier of claim 2 wherein said first and second members are formed of a single piece of material forming a carrier edge and having an aperture in said first member above said carrier edge.

7. The label carrier of claim 6 wherein said material comprises an elastomer.

8. The label carrier of claim 1 wherein said first member comprises an first surface that is positioned away from the pallet, said label being secured to said first surface.

9. The label carrier of claim 8 wherein said first surface comprises a depression for receiving said label.

10. The label carrier of claim 8 further comprising a second surface that is positioned towards the pallet, said second surface comprising an identification tag that supports wireless communication.

11. The label carrier of claim 11 wherein said second surface comprises a depression for receiving said identification tag.

12. The label carrier of claim 2 wherein said first member comprises a pair of downwardly-facing tongs, said downwardly-facing tongs acting to brace said label carrier against the pallet edge.

13. An identification tag carrier for use with a pallet having products stored thereon and having pallet edges and upper and lower pallet surfaces, said identification tag carrier comprising:
a first member and a second member that are oriented substantially perpendicular to each other;
releasable securing means that releasably secures said first and second member to an edge of the pallet, said releasable securing means positioning said second member to be in contact with the upper pallet surface and positioning said first member to be contact with the pallet edge; and
wherein said first member includes an identification tag which supports wireless communication.

14. The identification tag carrier of claim 13 wherein said releasable securing means comprises a clip having a U-shaped configuration comprising a pair of tongs.

15. The identification tag carrier of claim 14 wherein said first member and said second member form a carrier edge and wherein said first member comprises an aperture for permitting passage of one of said tongs.

16. The identification tag carrier of claim 15 wherein said second member comprises a depression therein, said depression receiving said one of said pair of tongs which passes through said aperture and presses downward against said upper pallet surface.

17. The identification tag carrier of claim 16 wherein said clip comprises spring steel.

18. The identification tag carrier of claim 14 wherein said first and second members are formed of a single piece of material forming a carrier edge and having an aperture in said first member above said carrier edge.

19. The identification tag carrier of claim 18 wherein said material comprises an elastomer.

20. The identification tag carrier of claim 13 wherein said first member comprises an first surface that is positioned away from the pallet, said identification tag being secured to said first surface.

21. The identification tag carrier of claim 20 wherein said first surface comprises a depression for receiving said label.

22. The identification tag carrier of claim 13 wherein said identification tag comprises an RFID tag.

23. The identification tag carrier of claim 13 wherein said identification tag comprises an EAS tag.
